(19) United States
(12) Patent Application Publication
(10) Pub. No.: US 2024/0288041 A1
(43) Pub. Date: Aug. 29, 2024

(54) FIELD-REPLACEABLE YAW BRAKE SLEEVE

(71) Applicant: Integrated Power Services, Sanford, NC (US)

(72) Inventors: Christopher James Winslow, Lemon Springs, NC (US); Matthew Kenneth King, Carthage, NC (US)

(73) Assignee: Integrated Power Services, Sanford, NC (US)

(21) Appl. No.: 18/587,583

(22) Filed: Feb. 26, 2024

Related U.S. Application Data
(60) Provisional application No. 63/448,508, filed on Feb. 27, 2023.

(51) Int. Cl. F16D 65/00; F03D 7/02; F16D 125/04

(52) U.S. Cl. CPC F16D 65/005; F03D 7/0204; F03D 7/0244; F05B 2260/90; F16D 2125/04; F16D 2250/0069; F16D 2250/0084

(57) ABSTRACT

A field-replaceable sleeve assembly for a yaw brake assembly of a wind turbine includes a sleeve body and a sleeve attachment portion. The sleeve body is configured to be installed from a top side of a turbine bedplate into a receiving portion of the turbine bedplate of the wind turbine and secured to the turbine bedplate by activation of the sleeve attachment portion from the top side of the turbine bedplate.

### CROSS-REFERENCE TO RELATED APPLICATIONS

This application claims the benefit of U.S. Provisional Patent Application No. 63/448,508 (filed on Feb. 27, 2023), the contents of which are incorporated herein by reference in their entirety.

### BACKGROUND

The present disclosure relates to wind turbines. More particularly, the present disclosure relates to yaw brakes for wind turbines.

A wind turbine includes a set of wind turbine blades, a nacelle, and a tower that supports the nacelle through a rotational coupling. The nacelle includes a rotor shaft with a hub to which the wind turbine blades are attached. The hub is rotationally coupled to an electrical generator, and the wind turbine converts wind energy to electrical energy by converting the aerodynamic forces (i.e., lift) imparted onto the turbine blades by the wind into rotation of the drive shaft of the electrical generator to produce electricity.

The nacelle includes a yaw system that holds the nacelle pointed into the wind, or that otherwise provides a resistance or damping to the rotation of the nacelle about the vertical axis of the tower. Generally, a yaw system for a utility-scale wind turbine may include yaw bearings to rotationally couple the nacelle to the tower, yaw brakes to control the rotation of the nacelle, and yaw drives to actively slew the nacelle to a desired direction.

In many wind turbines, the yaw system includes a number (e.g., 10, 12, 18, etc.) of hydraulic yaw brakes that are mounted to the frame of the nacelle. Each hydraulic yaw brake includes a hydraulic actuator that is coupled to a brake friction pad that engages a bearing surface at the top of the tower known as a slew ring. The hydraulic yaw brakes must absorb large static and dynamic loads created by forces and moments during wind turbine operation. In many cases, the components that couple the hydraulic actuator to the pad, as well as the pad itself, are inadequately designed and fail prematurely due to poor load distribution and ability to accommodate the system forces, torques, stresses, etc. These components can include the sleeve of the yaw brake, mounted into the bedplate of the turbine from the underside of the bedplate and nacelle. The yaw brake sleeve is also referred to as a yaw brake housing, a yaw brake frame, sleeve, etc. Generally, the turbine bedplate is cast iron, steel or other metal alloy, etc.

There is a need to be able to replace wearable components of a yaw brake, including yaw brake sleeves, even after components fail after usage in the field.

### BRIEF DESCRIPTION OF THE DRAWINGS

FIG. 1 depicts a cutaway view of an upper portion of a wind turbine.

FIGS. 2A-2F depict various views of a hydraulic yaw brake.

FIG. 3 depicts a yaw brake sleeve with representative dimensions shown.

FIGS. 4A-4B depict a single part field-replaceable sleeve assembly for a yaw brake assembly of a wind turbine, in accordance with an embodiment of the present disclosure.

FIGS. 5A-5C depict a field-replaceable sleeve assembly with a segment ring, in accordance with an embodiment of the present disclosure.

FIGS. 6A-6B depict a multiple-part field-replaceable sleeve assembly with mating bolt holes and mating pin holes, in accordance with an embodiment of the present disclosure.

FIGS. 7A-7C depict a multiple-part field-replaceable sleeve assembly with a circular flange, in accordance with an embodiment of the present disclosure.

FIGS. 8A-8C depict a multiple-part field-replaceable sleeve assembly with threaded sleeve attachment portions and a threaded circular flange, in accordance with an embodiment of the present disclosure.

FIGS. 9-A-9C depict a multiple-part field-replaceable sleeve assembly with a rectangular flange, in accordance with an embodiment of the present disclosure.

FIGS. 10A-10C depict a multiple-part field-replaceable sleeve assembly with a rectangular flange, in accordance with an embodiment of the present disclosure.

FIG. 11 depicts a field-replaceable sleeve assembly with threaded sleeve attachment portion, in accordance with an embodiment of the present disclosure.

FIGS. 12A-12D depict various views of a field-replaceable sleeve assembly with threaded sleeve attachment portion, in accordance with an embodiment of the present disclosure.

FIG. 13 depicts view of set screw suitable for use with a field-replaceable sleeve assembly with threaded sleeve attachment portion, in accordance with an embodiment of the present disclosure.

FIGS. 14A-14C depict various views of installation of a field-replaceable sleeve assembly with threaded sleeve attachment portion into a receiving portion of a bedframe, also threaded, in accordance with an embodiment of the present disclosure.

### DETAILED DESCRIPTION

Embodiments of the present disclosure will now be described with reference to the drawing figures, in which like reference descriptors refer to like parts throughout.

While embodiments of this disclosure may be described with respect to hydraulic (active) yaw brake applications, their use in spring-loaded (passive) yaw brake applications is also contemplated.

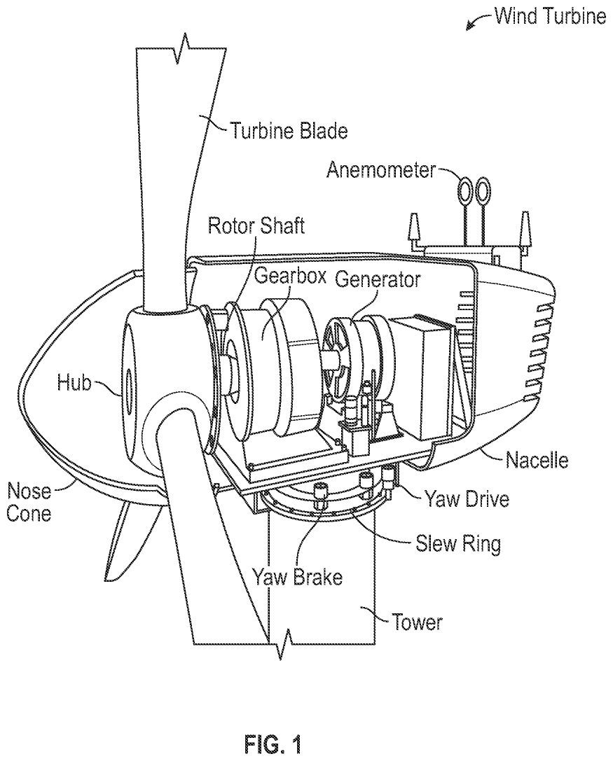

FIG. 1 depicts a cutaway view of the upper portion of a wind turbine. The wind turbine includes, inter alia, a set of wind turbine blades, a nacelle, and a tower that supports the nacelle through a rotational coupling. The nacelle includes a rotor shaft, coupled to the hub, to which the wind turbine blades are attached. The wind striking the turbine blades creates lift which causes the hub to rotate the drive shaft, which is coupled to a gearbox and an electrical generator within the nacelle, which converts the mechanical rotation into electricity. The orientation (“pitch”) of the turbine blades with respect to the hub is most often variable, and controlled to maintain the desired speed of the turbine through variable wind conditions.

The nacelle also includes a yaw system which generally provides a set of components structurally configured to facilitate the orientation of the nose cone and turbine blades towards the wind. The yaw system may include yaw bearings to rotationally couple the nacelle to the tower and yaw drives with associated motors, gearboxes and drive pinions to actively slew the nacelle to a desired direction. Mechanical or hydraulic yaw brakes are utilized to hold, lock, or otherwise steady the orientation or yaw position of the nacelle. Substantially all wind turbines include an anemometer that detects wind direction and speed and sends signals via a controller (e.g., a programmable logic controller, microcontroller, processor, etc.) to the components of the yaw system to adjust and then hold the yaw position of the nacelle.

A series of hydraulic yaw brakes are coupled together and activated by a hydraulic power station within the nacelle. Each yaw brake is attached within the nacelle framework, mounted into the cast bedplate of the turbine, and engages the slew ring of the tower, which is a large diameter disk made of steel, etc. The slew ring includes an outer or inner rim gear to engage the drive pinions of the yaw drives.

Each hydraulic brake includes a brake piston with a brake friction pad attached. The brake friction pad is structurally designed through force and friction to control rotation of the nacelle of the wind turbine, to provide relatively smooth rotation of the nacelle into the wind under a wide range of weather conditions, and to brake or stop the rotation of the nacelle at a particular orientation.

The brake friction pad may include a dry or lubricated pad that bears against the slew ring, and may be made from metal, such as brass, bronze, sintered bronze, oil impregnated bronze, etc., polymer, composite, sintered metal, polyether ether ketone (PEEK), layered synthetic fiber reinforced formulation having a wear layer of polyester resin and fabric with polytetrafluoroethylene (PTFE) fibers, etc. The brake friction pad is also referred to as a yaw bearing, a gliding yaw pad, a gliding yaw bearing, a yaw bearing pad, a yaw brake pad, a yaw puck, etc.

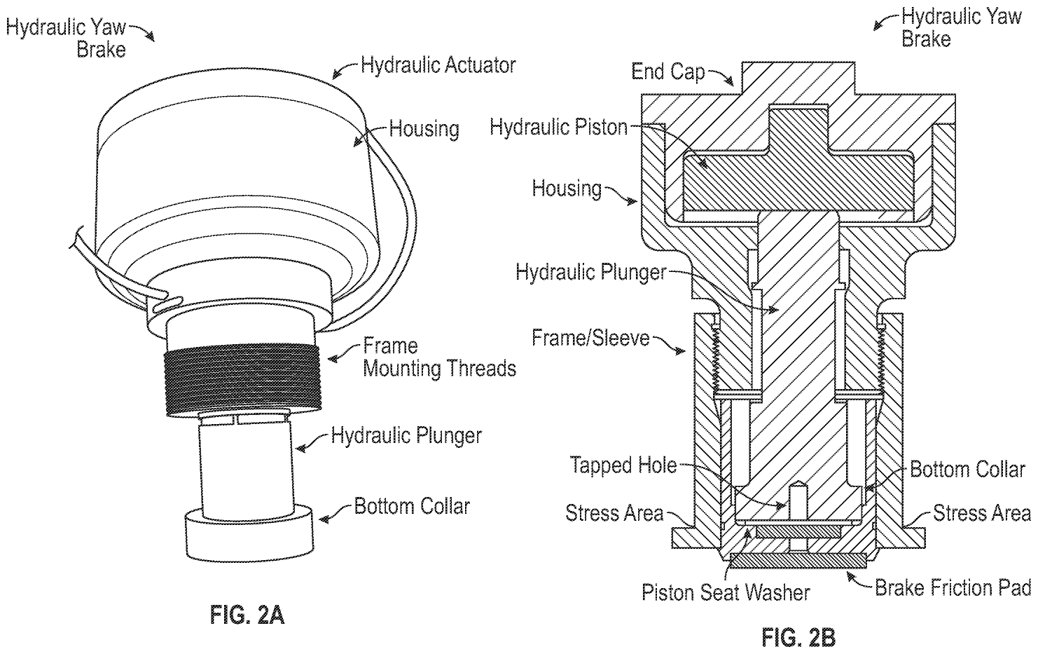

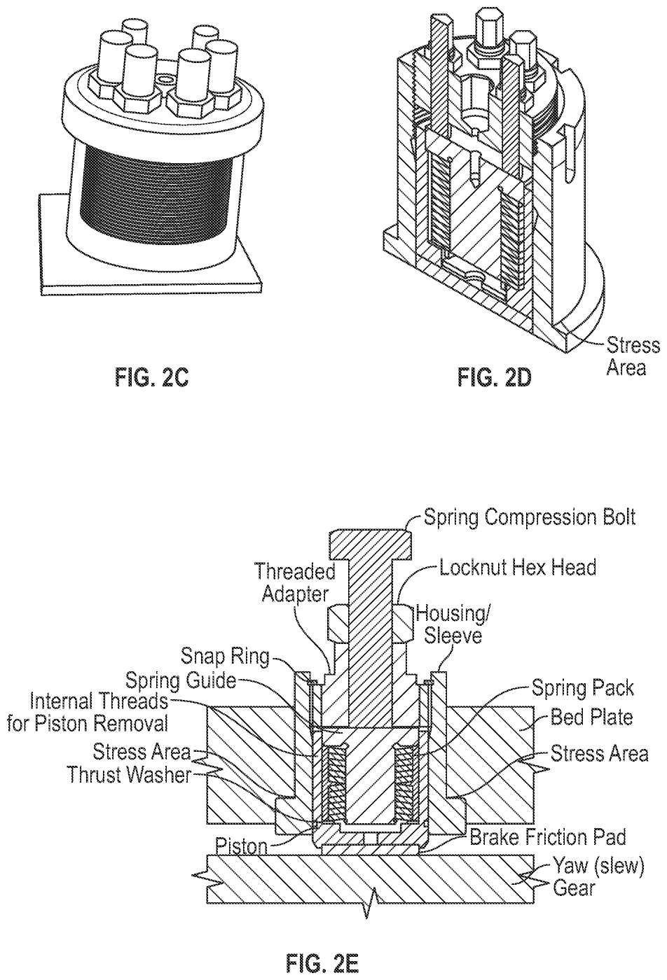

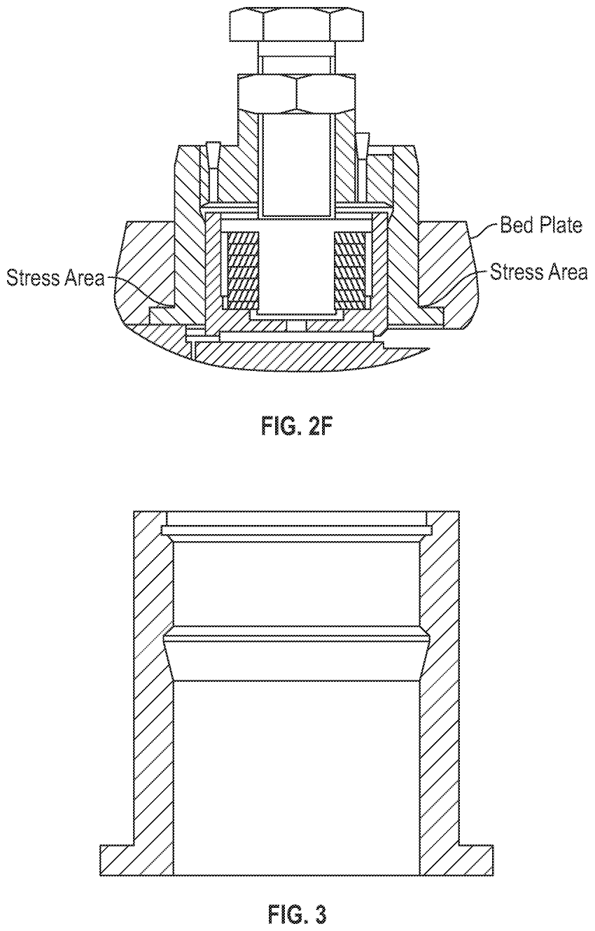

FIGS. 2A-2F depict various views of a hydraulic yaw brake. FIG. 2A depicts an exterior view of a hydraulic yaw brake, while FIG. 2B depicts a cross-sectional view of the hydraulic yaw brake. FIGS. 2C-2F show front, isometric and cross-sectional views, respectively, of an assembled hydraulic yaw brake; the bedplate into which the yaw brake assembly is mounted in shown in FIGS. 2E and 2F. The hydraulic pressure within the brake transfers a force from the hydraulic piston to the hydraulic plunger, then to the piston seat washer and finally to the brake piston. The upper surface of the hydraulic plunger contacts the hydraulic piston, and the bottom surface contacts the piston seat washer disposed within the brake piston. The hydraulic plunger encompasses a hex design to restrict rotation within the housing and a central tapped hole to facilitate easy extraction from the housing. During wind turbine operation the components that transfer the force to the brake friction pad, i.e., the sleeve, the hydraulic plunger, the piston seat washer, the brake piston, as well as the brake friction pad itself, are often found to be inadequately designed, and to wear and fail prematurely due to poor load distribution and inability to accommodate the system forces, torques, stresses, etc.

At the factory, the sleeve is mounted into the cast bedplate of the turbine from the underside of the casting and nacelle, as noted supra. Once the nacelle is installed atop the tower, the sleeve is located above the yaw ring/slew gear such that the sleeve cannot be removed without separating the nacelle from the slew ring which is affixed to the top of the tower. This is an extremely expensive process involving a large, expensive crane.

It has been found that over time sleeves can show various signs of wear and in some cases have failed catastrophically, e.g., via fracture. Due to the cost of field replacement, a worn or failed sleeve is typically not replaced; instead, the brake is abandoned, which places additional stress on the remaining brakes on the turbine. In FIGS. 2B, 2D, 2E and 2F, the label Stress Area denotes the area or point that commonly is subject to stress fractures, cracks, shears, etc. due to these forces, i.e. at the approximately 90 degree junction between the bottom flange of the sleeve body and the circular portion of the sleeve body.

In accordance with the various embodiments of the present disclosure, a field-replaceable sleeve assembly for a yaw brake assembly of a wind turbine has a sleeve body and a sleeve attachment portion. The field-replaceable sleeve assembly can be placed into the bedplate of a turbine from above, i.e. the top side of the turbine bedplate, thereby allowing defective sleeves to be replaced while the wind turbine is in the field. The sleeve body is accordingly installed from a top side of a turbine bedplate into a receiving portion of the turbine bedplate of the wind turbine and secured to the turbine bedplate by activation of the sleeve attachment portion from the top side of the turbine bedplate. As described and shown herein, the sleeve attachment portion may be a flange and/or threaded features to permit the sleeve assembly to be secured to the top side of the turbine bedplate once installed. If a flange, of which various shapes are shown and described herein, the flange may be sized and shaped to accommodate a number of sleeve bodies. Activation of the sleeve attachment portion may be using bolts, dowels, pins, welding to secure a flange to the bedplate or it may be threading into threaded portions of the sleeve body into the bedframe. Additionally, dowels, bolts, welding, and adhesives may be used in connection with the sleeve attachment portion of the sleeve assembly. As also described and shown herein, the sleeve assembly may be a single piece or of a unitary construction or it may be formed of multiple-parts.

According to an embodiment of the present disclosure, an alternative for field repair is a field-replaceable sleeve. In certain embodiments, a flange is coupled to a top section of the sleeve. The flange has holes in it for a series of bolts which attach the flange and, therefore, the sleeve, to the turbine bedplate. Advantageously, such a sleeve may be mounted and installed from the top, rather than the bottom, of the turbine bedplate. In other embodiments, the sleeve itself has threaded portions, such as threads on the outer diameter of the sleeve body that permits the sleeve to be threaded or screwed into the bedplate. As will be shown, the flange and threaded portions may be used together as sleeve attachment options. The sleeve may be made from metal, such as steel or other material able to withstand and absorb large static and dynamic loads created by forces and moments during wind turbine operation.

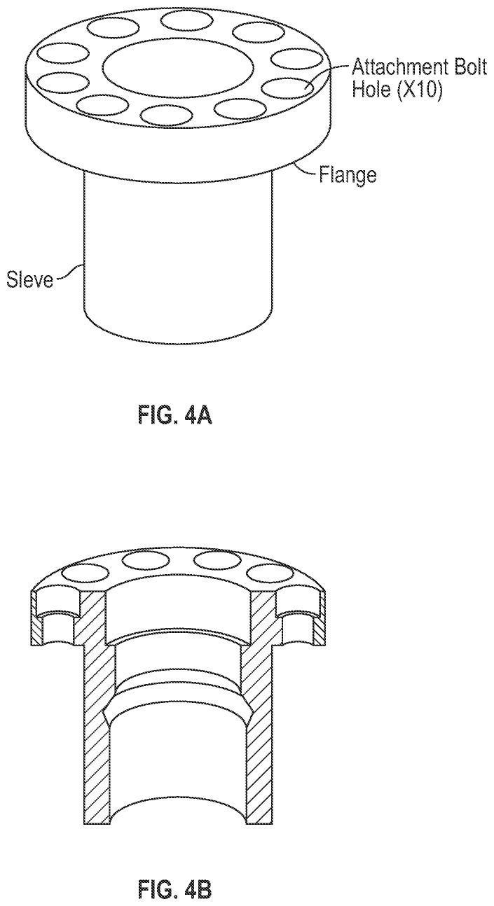

Referring now to FIGS. 4A-4B, a sleeve body and a flange is illustrated. During a field repair, a damaged sleeve is removed from the turbine bedplate (e.g., cut out, machined out, tapped, etc.). Corresponding holes in the same pattern as the flange, for example, are drilled and threaded in the turbine bedplate to accept the attachment bolts that are used to hold the flange in place. A jig, fixture or template may be employed onsite to locate the holes to be drilled in the turbine bedplate. A sleeve with a top flange is installed in the bore. The attachment bolts are then placed and the flange attached to the turbine bedplate.

Advantageously, the sleeve with a top flange enables field repair of the sleeve without removal of the nacelle, saving the time and expense of the crane.

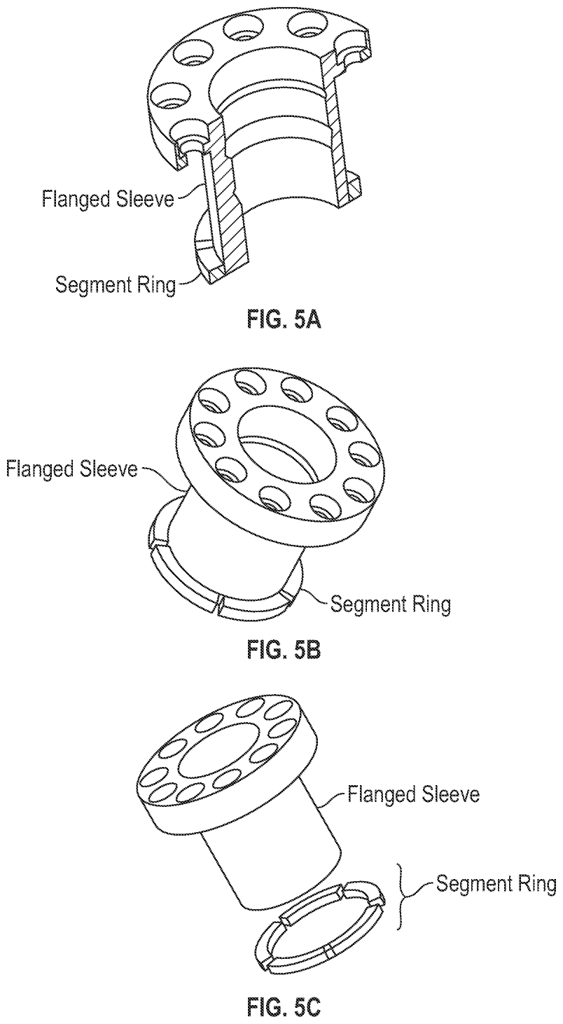

When the damaged sleeve is removed from the turbine bedplate, a void is left at the base of the bore. Left unfilled, this void may allow an undesirable rotation of the base of the brake frame (sleeve). According to an embodiment of the present disclosure, to fill this void, a segment ring mates with the field-replaceable sleeve. Made as several (e.g., four) arc segments, the segment ring is installed from the top of the bedframe, and is compatible with any of the disclosed embodiments described supra. The segment ring that mates with the sleeve assembly is illustrated in FIGS. 5A-5B.

While FIGS. 4A-4B and FIGS. 5A-5C show that the sleeve body and the flange of the sleeve assembly may be formed of a single, unitary and solid piece of metal, for example, in other embodiments of the present disclosure, the flange and sleeve are fabricated in multiple (i.e., separate) parts. Attachment of the flange and sleeve can be by at least one of bolts, dowel pins, threaded features, welding, etc. In either approach the repair sleeve assembly will be installed from the top of the bedframe.

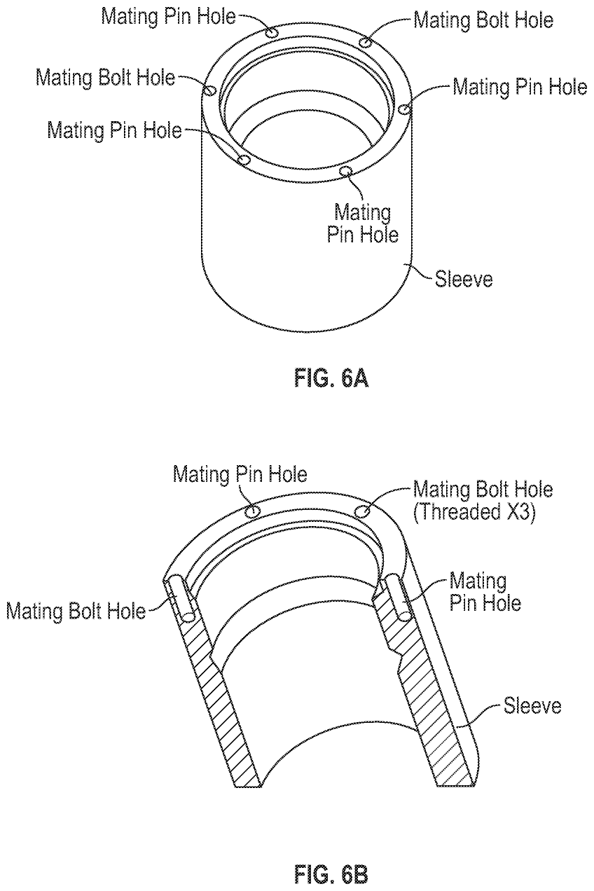

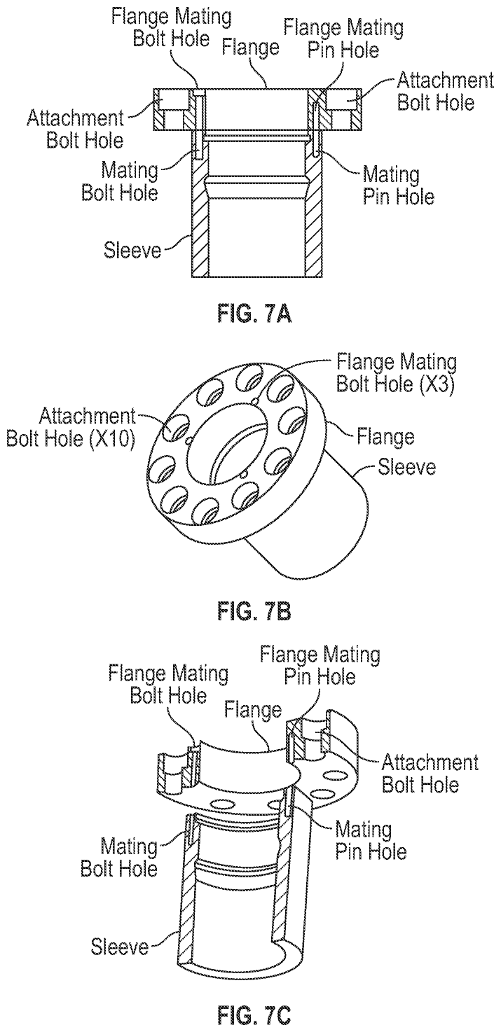

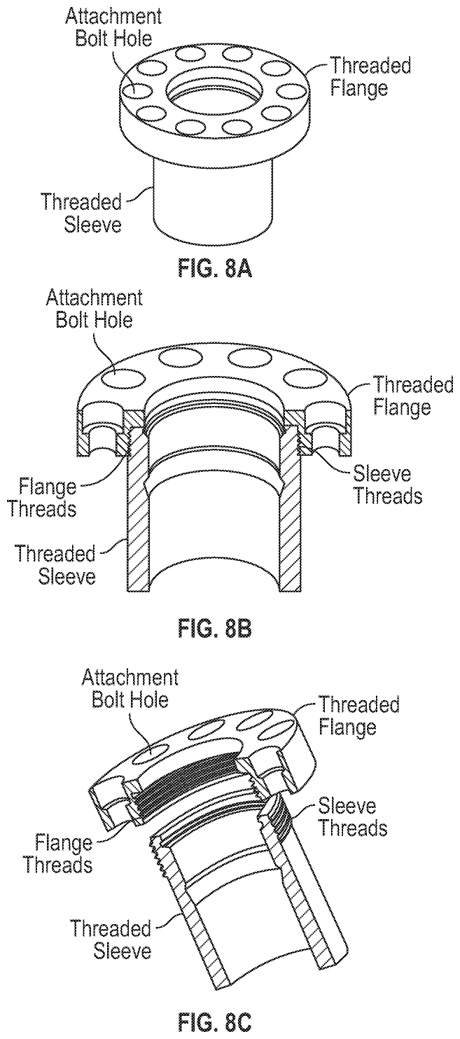

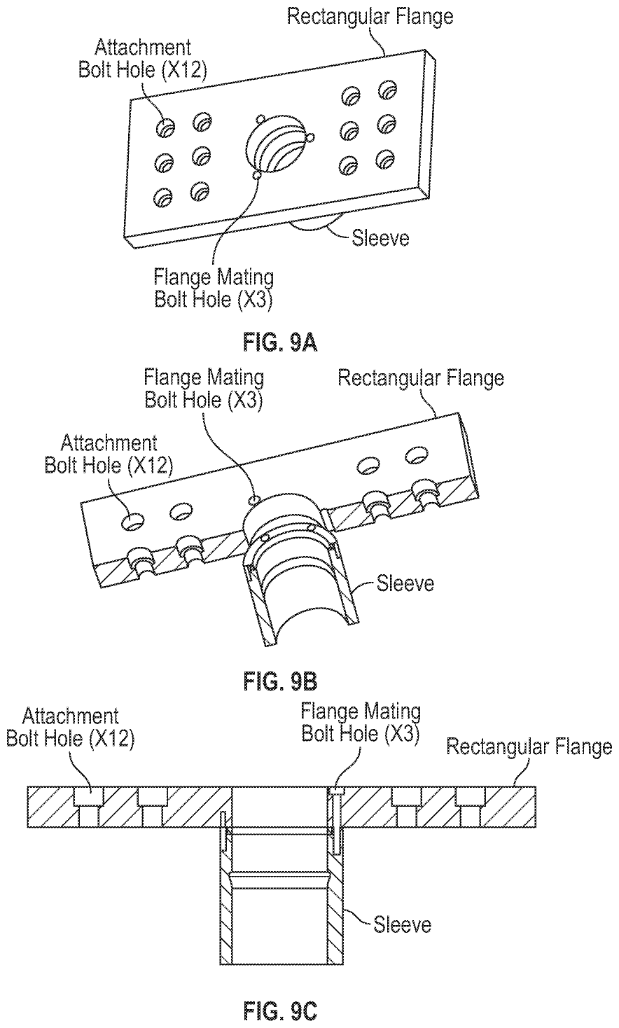

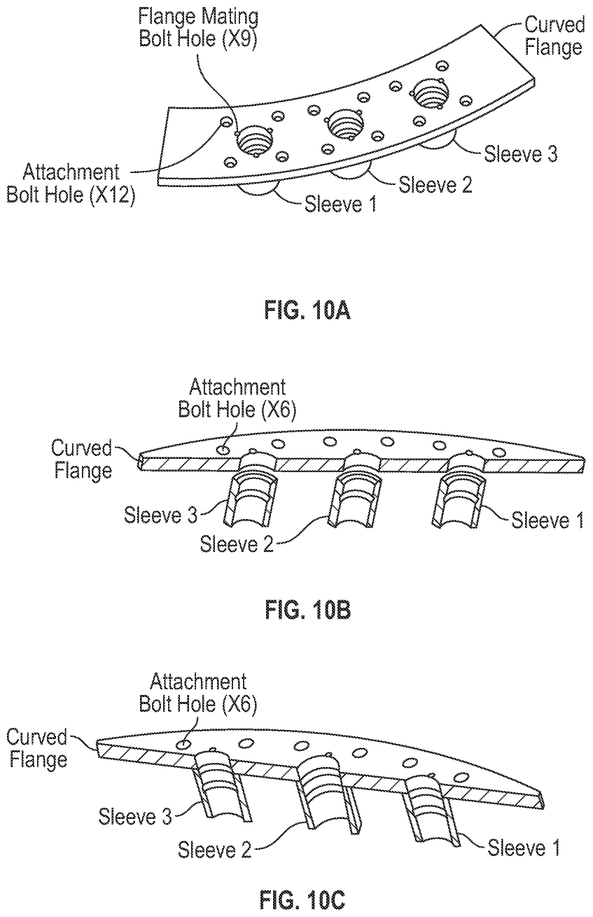

The flange and sleeve can be attached by a number of bolts, e.g., six bolts. Bolts have the advantage of rapid assembly and disassembly. For greater shear strength, one or more bolts, e.g., three bolts, may be replaced with dowel pins. In FIGS. 6A-6B, the use of dowels, pins and/or bolts allows the sleeve body to be mated with various flanges, including those shown in FIGS. 7A-7C (circular), FIGS. 9A-9C (rectangular) and FIGS. 10A-10C (curved). In FIGS. 7A-7C, for example, this embodiment provides a circular style flange to be mated with a single sleeve body as shown. The sleeve lines up with dowel pins, the sleeve and flange are bolted together, and then the assembly is bolted to the bedframe. Welding after attachment to the bedframe would provide for even more holding strength. For even more rapid assembly and disassembly, the flange may include one or more threaded features that thread onto mating threaded features on the sleeve. As shown in FIGS. 8A-8C, a multiple-part sleeve assembly has a circular style attached flange that is threaded. The sleeve body threads onto the mating flange and the assembly can then be bolted to the bedframe. The flange may also be welded to the sleeve, in combination with one or more of the above attachment methods or as the sole attachment method.

One advantage of an embodiment incorporating the sleeve and flange as separate parts is savings on manufacturing expense, since less material is removed in production than a single-part design. Another advantage is that a flange can be made that would fit one or alternatively a plurality (2, 3, 4, etc.) of brake positions. For example, a flange resembling the shape of an “8” could be used to take care of two holes in the bedplate and have two corresponding sleeves attaching to the single flange. In addition, the flange may be curved to accommodate a plurality of sleeves around an arc of the bedframe.

Referring now to FIGS. 9A-10C, various shaped flanges are illustrated. In FIGS. 9A-9C, the sleeve attachment portion is a rectangular shaped flange. The larger body of the flange in this example provides the ability to use more bolts and a larger surface area when securing the sleeve assembly to the bedframe. In FIGS. 10A-10C, a curved flange is illustrated. This variation provides the ability to cover a plethora of different bedframe bore sleeves. In this illustration, it can be seen that a curved flange can be used with a number of sleeve bodies, three sleeves in this example. It is envisioned and contemplated that any of the flange shapes shown in FIGS. 9A-10C may be used with multiple replacement sleeve assemblies. Accordingly, the flange is configured to accommodate a plurality of sleeve bodies.

According to another embodiment of the present disclosure, threads are included on the outside diameter (OD) of the sleeve. In the field, threads are added to the bore in the bedplate and the sleeve then threads into the baseplate (bedplate). This embodiment may or may not have a flange, bolts, etc. A feature is included to ensure the sleeve cannot un-thread (i.e., back out of the bore). This feature may comprise setscrews, locking rings (e.g., one or more of lock washers and lock nuts), a bar or feature to attach the top of the sleeve to another feature in the nacelle, etc. This approach simply requires the mating hole in the bedframe to have matching thread cut, such as tapped or machined, into the bedframe to accept the new replacement sleeve assembly with threads on its outside diameter. An advantage of this embodiment is not having to drill or make other new holes in the thread.

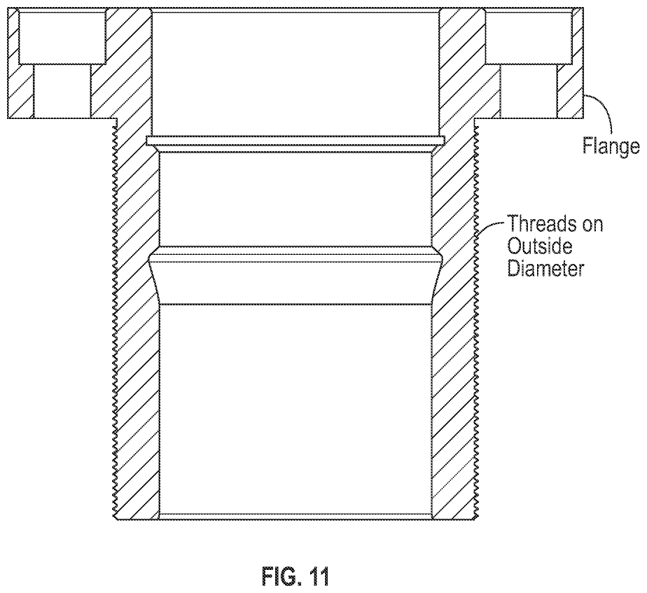

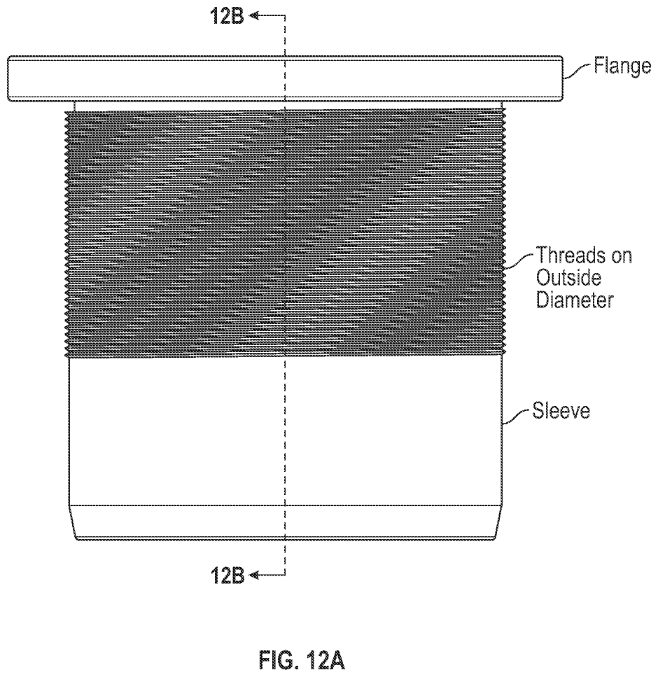

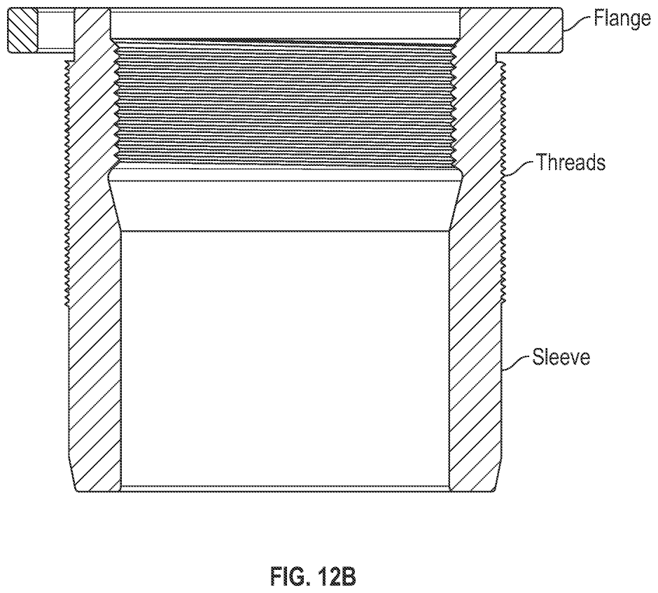

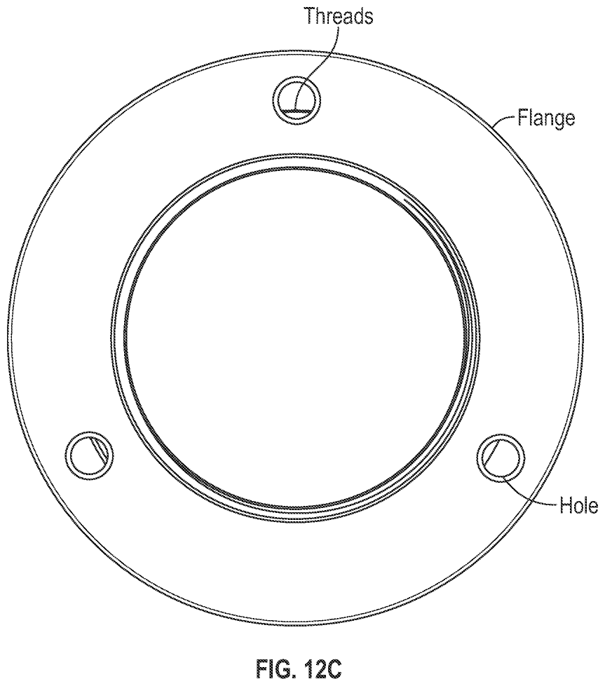

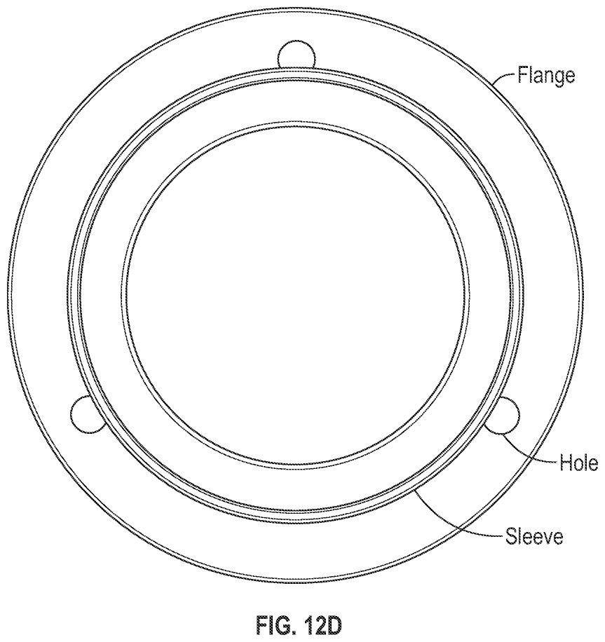

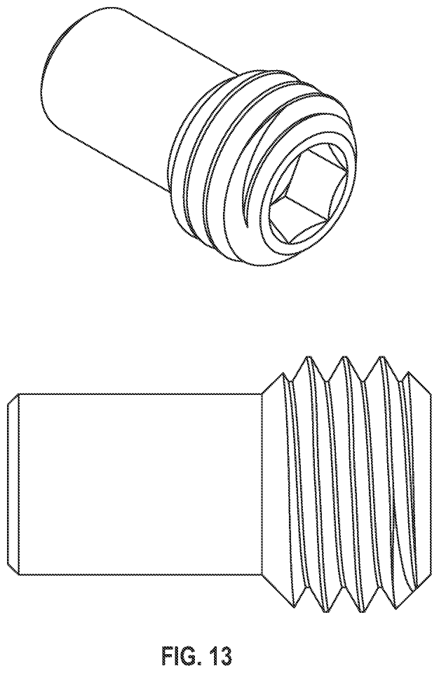

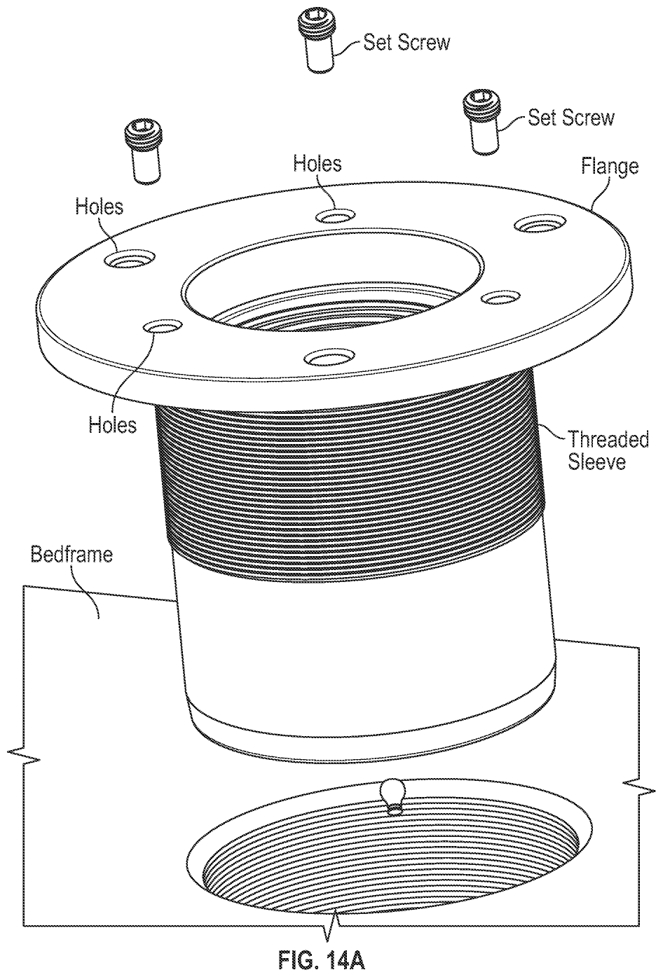

Referring to FIGS. 11 and 12A-12D, the sleeve attachment portion of the sleeve assembly is threads on the OD of the sleeve body. As shown in the drawings, the threads may extend substantially the length of the sleeve body to provide more mating strength, though this is not required. In the field, as a repair is needed, corresponding threads are added to the bore after the faulty sleeve is removed. This embodiment may or may not be used with a flange, bolts, dowels, pins, etc. The addition of an adhesive such as Loctite or other glue on the mating threads will further strengthen the attachment. Following the placement of the sleeve assembly by threading into the bore, a set screw, such as that depicted in FIG. 13 can be used in each of the holes shown in FIGS. 12C and 12D.

In a preferred embodiment of the sleeve assembly in which the sleeve attachment portion is threaded on the OD of the sleeve body, a dowel pin is used to keep the sleeve from un-threading once it is installed. The replacement sleeve assembly is threaded into the turbine bedplate, matching with mating threads cut into the bedplate. Where the holes are shown in FIGS. 12C and 12D, the bedplate is drilled through the holes and a threaded dowl is installed that will “pin” or secure the replacement sleeve assembly in place.

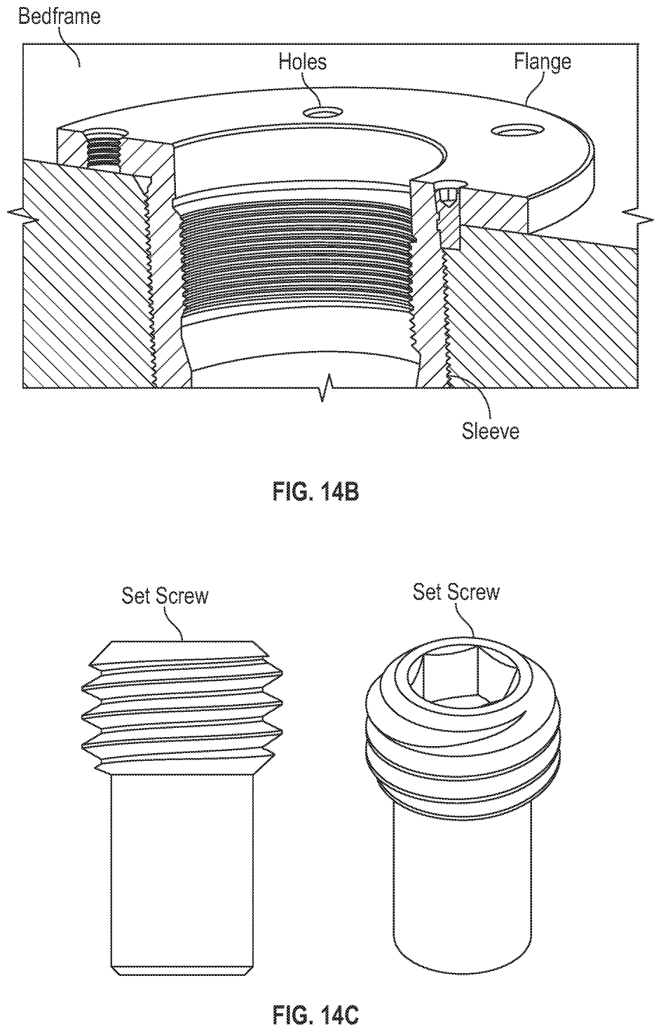

In view of the foregoing, an installation process is shown and described with reference to FIGS. 14A-14C. First a thread is added to existing bedframe holes in the bedframe, such as where the faulty, factory-installed, original sleeve has been removed. This accommodates matching threads on the threaded sleeve portion so that the replacement sleeve can be screwed into place. Once in place, holes can be drilled to house the set screws screwed into each of the drilled holes. For examples, in certain embodiments, 8.5 mm holes roughly 9-10 mm deep can be drilled to accommodate the set screws. As previously above, set screws as shown will keep the sleeve from rotating once installed.

By way of example and not limitation, with regard to the top mount threaded sleeve embodiments shown in FIGS. 11-14, example dimensions of the field-replaceable sleeve assembly may be as follows: M16x2.0 threaded holes in the flange, M12x1.75 threaded pin holes, M127x2.0 threaded sleeve, 70 mm length of the thread on the outside diameter of the sleeve, 200 mm Ø flange 12.7 mm thick, and 3 mm×3 mm undercut from the bottom of the flange above the top of the threads on the outside diameter of the sleeve.

When the damaged sleeve is removed from the turbine bedplate, a void is left at the base of the bore. Left unfilled, this void may allow an undesirable rotation of the base of the brake frame (sleeve). According to an embodiment of the present disclosure, to fill this void, a segment ring mates with the field-replaceable sleeve. Made as several (e.g., four) arc segments, the segment ring is installed from the top of the bedframe, and is compatible with any of the disclosed embodiments described supra. Reference to FIGS. 5A-5C show use of a segment ring.

The following embodiments are combinable.

In one embodiment, a field-replaceable sleeve assembly for a yaw brake assembly of a wind turbine has a sleeve body and a sleeve attachment portion. The sleeve can be installed from a top side of a turbine bedplate into a receiving portion of the turbine bedplate of the wind turbine and secured to the turbine bedplate by activation of the sleeve attachment portion from the top side of the turbine bedplate.

In another embodiment of the field-replaceable sleeve assembly, the sleeve attachment portion includes a flange coupled to a top portion of the sleeve body and where the field-replaceable sleeve assembly is installed from the top side of the turbine bedplate into the turbine bedplate by placement of a bottom portion of the sleeve body into the receiving portion of the turbine bedplate and by attachment of the flange to the top side of the turbine bedplate.

In another embodiment of the field-replaceable sleeve assembly, the flange is of unitary construction with the sleeve body.

In another embodiment of the field-replaceable sleeve assembly, the flange is attached to the top side of the turbine bedplate by one or more of dowels, bolts, welding and threads.

In another embodiment of the field-replaceable sleeve assembly, the flange is configured to accommodate a plurality of sleeve bodies.

In another embodiment of the field-replaceable sleeve assembly, the sleeve attachment portion including a threaded portion of the sleeve body that mates to corresponding threads in the receiving portion of the turbine bedplate. The field-replaceable sleeve assembly is installed from the top side of the turbine bedplate into the turbine bedplate by engagement of the threaded portion of the sleeve body with corresponding threads in the receiving portion of the turbine bedplate to seat the field-replaceable sleeve assembly into the receiving portion of the turbine bedplate.

In another embodiment of the field-replaceable sleeve assembly, the sleeve attachment portion further includes a flange coupled to a top portion of the sleeve body. The field-replaceable sleeve assembly is installed from the top side of the turbine bedplate into the turbine bedplate by engagement of the threaded portion of the sleeve body with corresponding threads in the receiving portion of the turbine bedplate to seat the field-replaceable sleeve assembly into the receiving portion of the turbine bedplate and by attachment of the flange to the top side of the turbine bedplate.

In another embodiment of the field-replaceable sleeve assembly, an adhesive is added, affixed to one or both of the threaded portion of the sleeve body and the corresponding threads in the receiving portion of the turbine bedplate.

In another embodiment of the field-replaceable sleeve assembly, the flange is attached to the top side of the turbine bedplate by dowels, bolts, welding and/or threads.

In another embodiment of the field-replaceable sleeve assembly, the sleeve attachment portion includes a threaded portion located on an outside diameter of the sleeve body.

In another embodiment of the field-replaceable sleeve assembly, the threaded portion on the outside diameter of the sleeve body covers substantially a length of the sleeve body.

In another embodiment of the field-replaceable sleeve assembly, the field-replaceable sleeve assembly is installed from the top side of the turbine bedplate into the turbine bedplate by engagement of the threaded portion located on the outside diameter of the sleeve body with corresponding threads in the receiving portion of the turbine bedplate to seat the field-replaceable sleeve assembly into the receiving portion of the turbine bedplate.

In another embodiment of the field-replaceable sleeve assembly, the sleeve body of the sleeve is cylindrical.

In another embodiment of the field-replaceable sleeve assembly, the turbine bedplate and a nacelle to which the turbine bedplate is coupled are located atop a tower of the wind turbine when the field-replaceable sleeve assembly is installed into the turbine bedplate.

In another embodiment of the field-replaceable sleeve assembly, the sleeve attachment portion is configured to accommodate a plurality of sleeve bodies.

In one embodiment, a field-replaceable sleeve assembly for a yaw brake assembly of a wind turbine has a sleeve body portion and a threaded portion coupled to the sleeve body portion. The field-replaceable sleeve assembly is configured to be installed from a top side of a turbine bedplate into a receiving portion of the turbine bedplate of the wind turbine and secured to the turbine bedplate by activation of the threaded portion from the top side of the turbine bedplate.

In another embodiment of the field-replaceable sleeve assembly, the threaded portion is located on an outside diameter of the sleeve body portion.

In another embodiment of the field-replaceable sleeve assembly, the threaded portion on the outside diameter of the sleeve body covers substantially a length of the sleeve body portion.

In another embodiment of the field-replaceable sleeve assembly, the field-replaceable sleeve assembly is installed from the top side of the turbine bedplate into the turbine bedplate by engagement of the threaded portion located on the outside diameter of the sleeve body portion with corresponding threads in the receiving portion of the turbine bedplate to seat the field-replaceable sleeve assembly into the receiving portion of the turbine bedplate.

In another embodiment of the field-replaceable sleeve assembly, further including an adhesive affixed to one or more of the threaded portion located on the outside diameter of the sleeve body portion and the corresponding threads in the receiving portion of the turbine bedplate.

In another embodiment of the field-replaceable sleeve assembly, the field-replaceable sleeve assembly further has a flange portion coupled to a top portion of the sleeve body portion, where the field-replaceable sleeve assembly is installed from the top side of the turbine bedplate into the turbine bedplate by placement of a bottom portion of the sleeve body portion into the receiving portion of the turbine bedplate and by attachment of the flange portion to the top side of the turbine bedplate.

In another embodiment of the field-replaceable sleeve assembly, the flange portion is of unitary construction with the sleeve body.

In another embodiment of the field-replaceable sleeve assembly, the flange portion is attached to the top side of the turbine bedplate by one or more of dowels, bolts, welding and threads.

In another embodiment of the field-replaceable sleeve assembly, further including an adhesive affixed to one or more of the threaded portion located on the outside diameter of the sleeve body portion and the corresponding threads in the receiving portion of the turbine bedplate.

In one embodiment, a field-replaceable sleeve assembly for a yaw brake assembly of a wind turbine includes a sleeve body portion and a flange portion coupled to the sleeve body portion. The sleeve body is configured to be installed from a top side of a turbine bedplate into a receiving portion of the turbine bedplate of the wind turbine and secured to the turbine bedplate by activation of the flange portion from the top side of the turbine bedplate.

In another embodiment of the field-replaceable sleeve assembly, the flange portion coupled to a top portion of the sleeve body portion and the field-replaceable sleeve assembly is installed from the top side of the turbine bedplate into the turbine bedplate by placement of a bottom portion of the sleeve body portion into the receiving portion of the turbine bedplate and by attachment of the flange portion to the top side of the turbine bedplate.

In another embodiment of the field-replaceable sleeve assembly, the flange portion is of unitary construction with the sleeve body portion.

In another embodiment of the field-replaceable sleeve assembly, the flange portion is attached to the top side of the turbine bedplate by one or more of dowels, bolts, welding and threads.

In another embodiment of the field-replaceable sleeve assembly, the sleeve body portion includes a threaded portion located on an outside diameter of the sleeve body portion.

In another embodiment of the field-replaceable sleeve assembly, the field-replaceable sleeve assembly is installed from the top side of the turbine bedplate into the turbine bedplate by engagement of the threaded portion located on the outside diameter of the sleeve body portion with corresponding threads in the receiving portion of the turbine bedplate to seat the field-replaceable sleeve assembly into the receiving portion of the turbine bedplate and by attachment of the flange portion to the top side of the turbine bedplate.

In another embodiment of the field-replaceable sleeve assembly, further including an adhesive affixed to one or more of the threaded portion located on the outside diameter of the sleeve body portion and the corresponding threads in the receiving portion of the turbine bedplate.

In another embodiment of the field-replaceable sleeve assembly, the flange is attached to the top side of the turbine bedplate by one or more of dowels, bolts, welding and threads.

In another embodiment of the field-replaceable sleeve assembly, the sleeve body portion is cylindrical.

In another embodiment of the field-replaceable sleeve assembly, the turbine bedplate and a nacelle to which the turbine bedplate is coupled are located atop a tower of the wind turbine when the field-replaceable sleeve assembly is installed into the turbine bedplate.

In another embodiment of the field-replaceable sleeve assembly, the flange portion is circular, curved or rectangular in shape.

In another embodiment of the field-replaceable sleeve assembly, the flange portion is configured to accommodate a plurality of sleeve body portions.

While implementations of the disclosure are susceptible to embodiment in many different forms, there is shown in the drawings and will herein be described in detail specific embodiments, with the understanding that the present disclosure is to be considered as an example of the principles of the disclosure and not intended to limit the disclosure to the specific embodiments shown and described. In the description above, like reference numerals may be used to describe the same, similar or corresponding parts in the several views of the drawings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive. Also, grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth. References to items in the singular should be understood to include items in the plural, and vice versa, unless explicitly stated otherwise or clear from the text.

Recitation of ranges of values herein are not intended to be limiting, referring instead individually to any and all values falling within the range, unless otherwise indicated, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” “for example,” or the like) provided herein, is intended merely to better illuminate the embodiments and does not pose a limitation on the scope of the embodiments. No language in the specification should be construed as indicating any unclaimed element as essential to the practice of the embodiments.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

In the following description, it is understood that terms such as “first,” “second,” “top,” “bottom,” “up,” “down,” “above,” “below,” and the like, are words of convenience and are not to be construed as limiting terms. Also, the terms apparatus, device, system, etc. may be used interchangeably in this text.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described and, accordingly, all suitable modifications and equivalents may be resorted to that fall within the scope of the disclosure.

What is claimed is:

1. A field-replaceable sleeve assembly for a yaw brake assembly of a wind turbine, comprising:
a sleeve body;
a sleeve attachment portion,
the sleeve body configured to be installed from a top side of a turbine bedplate into a receiving portion of the turbine bedplate of the wind turbine and secured to the turbine bedplate by activation of the sleeve attachment portion from the top side of the turbine bedplate.

2. The field-replaceable sleeve assembly of claim 1, the sleeve attachment portion including a flange coupled to a top portion of the sleeve body and where the field-replaceable sleeve assembly is installed from the top side of the turbine bedplate into the turbine bedplate by placement of a bottom portion of the sleeve body into the receiving portion of the turbine bedplate and by attachment of the flange to the top side of the turbine bedplate.

3. The field-replaceable sleeve assembly of claim 2, where the flange is of unitary construction with the sleeve body.

4. The field-replaceable sleeve assembly of claim 2, where the flange is attached to the top side of the turbine bedplate by one or more of dowels, bolts, welding and threads.

5. The field-replaceable sleeve assembly of claim 2, where the flange is configured to accommodate a plurality of sleeve bodies.

6. The field-replaceable sleeve assembly of claim 1, the sleeve attachment portion including a threaded portion of the sleeve body configured to mate to corresponding threads in the receiving portion of the turbine bedplate, where the field-replaceable sleeve assembly is installed from the top side of the turbine bedplate into the turbine bedplate by engagement of the threaded portion of the sleeve body with corresponding threads in the receiving portion of the turbine bedplate to seat the field-replaceable sleeve assembly into the receiving portion of the turbine bedplate.

7. The field-replaceable sleeve assembly of claim 6, the sleeve attachment portion further including a flange coupled to a top portion of the sleeve body, where the field-replaceable sleeve assembly is installed from the top side of the turbine bedplate into the turbine bedplate by engagement of the threaded portion of the sleeve body with corresponding threads in the receiving portion of the turbine bedplate to seat the field-replaceable sleeve assembly into the receiving portion of the turbine bedplate and by attachment of the flange to the top side of the turbine bedplate.

8. The field-replaceable sleeve assembly of claim 7, further including an adhesive affixed to one or more of the threaded portion of the sleeve body and the corresponding threads in the receiving portion of the turbine bedplate.

9. The field-replaceable sleeve assembly of claim 8, where the flange is attached to the top side of the turbine bedplate by one or more of dowels, bolts, welding and threads.

10. The field-replaceable sleeve assembly of claim 6, further including an adhesive affixed to one or more of the threaded portion of the sleeve body and the corresponding threads in the receiving portion of the turbine bedplate.

11. The field-replaceable sleeve assembly of claim 6, where the sleeve attachment portion includes a threaded portion located on an outside diameter of the sleeve body.

12. The field-replaceable sleeve assembly of claim 11, where the threaded portion on the outside diameter of the sleeve body covers substantially a length of the sleeve body.

13. The field-replaceable sleeve assembly of claim 12, where the field-replaceable sleeve assembly is installed from the top side of the turbine bedplate into the turbine bedplate by engagement of the threaded portion located on the outside diameter of the sleeve body with corresponding threads in the receiving portion of the turbine bedplate to seat the field-replaceable sleeve assembly into the receiving portion of the turbine bedplate.

14. The field-replaceable sleeve assembly of claim 13, the sleeve attachment portion further including a flange coupled to a top portion of the sleeve body, where the field-replaceable sleeve assembly is installed from the top side of the turbine bedplate into the turbine bedplate by engagement of the threaded portion located on the outside diameter of the sleeve body with corresponding threads in the receiving portion of the turbine bedplate to seat the field-replaceable sleeve assembly into the receiving portion of the turbine bedplate and by attachment of the flange to the top side of the turbine bedplate.

15. The field-replaceable sleeve assembly of claim 14, further including an adhesive affixed to one or more of the threaded portion located on the outside diameter of the sleeve body and the corresponding threads in the receiving portion of the turbine bedplate.

16. The field-replaceable sleeve assembly of claim 14, where the flange is attached to the top side of the turbine bedplate by one or more of dowels, bolts, welding and threads.

17. The field-replaceable sleeve assembly of claim 1, where the sleeve body of the sleeve is cylindrical.

18. The field-replaceable sleeve assembly of claim 1, where the turbine bedplate and a nacelle to which the turbine bedplate is coupled are located atop a tower of the wind turbine when the field-replaceable sleeve assembly is installed into the turbine bedplate.

19. The field-replaceable sleeve assembly of claim 1, where the sleeve attachment portion is configured to accommodate a plurality of sleeve bodies.

20. A field-replaceable sleeve assembly for a yaw brake assembly of a wind turbine, comprising:
a sleeve body portion;
a threaded portion coupled to the sleeve body portion,
the field-replaceable sleeve assembly configured to be installed from a top side of a turbine bedplate into a receiving portion of the turbine bedplate of the wind turbine and secured to the turbine bedplate by activation of the threaded portion from the top side of the turbine bedplate.

21. The field-replaceable sleeve assembly of claim 20, where the threaded portion is located on an outside diameter of the sleeve body portion.

22. The field-replaceable sleeve assembly of claim 21, where the threaded portion on the outside diameter of the sleeve body covers substantially a length of the sleeve body portion.

23. The field-replaceable sleeve assembly of claim 21, where the field-replaceable sleeve assembly is installed from the top side of the turbine bedplate into the turbine bedplate by engagement of the threaded portion located on the outside diameter of the sleeve body portion with corresponding threads in the receiving portion of the turbine bedplate to seat the field-replaceable sleeve assembly into the receiving portion of the turbine bedplate.

24. The field-replaceable sleeve assembly of claim 21, further including an adhesive affixed to one or more of the threaded portion located on the outside diameter of the sleeve body portion and the corresponding threads in the receiving portion of the turbine bedplate.

25. The field-replaceable sleeve assembly of claim 20, further comprising:
a flange portion coupled to a top portion of the sleeve body portion,
where the field-replaceable sleeve assembly is installed from the top side of the turbine bedplate into the turbine bedplate by placement of a bottom portion of the sleeve body portion into the receiving portion of the turbine bedplate and by attachment of the flange portion to the top side of the turbine bedplate.

26. The field-replaceable sleeve assembly of claim 25, where the flange portion is of unitary construction with the sleeve body.

27. The field-replaceable sleeve assembly of claim 25, where the flange portion is attached to the top side of the turbine bedplate by one or more of dowels, bolts, welding and threads.

28. The field-replaceable sleeve assembly of claim 25, further including an adhesive affixed to one or more of the threaded portion located on the outside diameter of the sleeve body portion and the corresponding threads in the receiving portion of the turbine bedplate.

29. A field-replaceable sleeve assembly for a yaw brake assembly of a wind turbine, comprising:
a sleeve body portion;
a flange portion coupled to the sleeve body portion,
the sleeve body configured to be installed from a top side of a turbine bedplate into a receiving portion of the turbine bedplate of the wind turbine and secured to the turbine bedplate by activation of the flange portion from the top side of the turbine bedplate.

30. The field-replaceable sleeve assembly of claim 29, the flange portion coupled to a top portion of the sleeve body portion and where the field-replaceable sleeve assembly is installed from the top side of the turbine bedplate into the turbine bedplate by placement of a bottom portion of the sleeve body portion into the receiving portion of the turbine bedplate and by attachment of the flange portion to the top side of the turbine bedplate.

31. The field-replaceable sleeve assembly of claim 30, where the flange portion is of unitary construction with the sleeve body portion.

32. The field-replaceable sleeve assembly of claim 30, where the flange portion is attached to the top side of the turbine bedplate by one or more of dowels, bolts, welding and threads.

33. The field-replaceable sleeve assembly of claim 29, where the sleeve body portion includes a threaded portion located on an outside diameter of the sleeve body portion.

34. The field-replaceable sleeve assembly of claim 33, where the field-replaceable sleeve assembly is installed from the top side of the turbine bedplate into the turbine bedplate by engagement of the threaded portion located on the outside diameter of the sleeve body portion with corresponding threads in the receiving portion of the turbine bedplate to seat the field-replaceable sleeve assembly into the receiving portion of the turbine bedplate and by attachment of the flange portion to the top side of the turbine bedplate.

35. The field-replaceable sleeve assembly of claim 34, further including an adhesive affixed to one or more of the threaded portion located on the outside diameter of the sleeve body portion and the corresponding threads in the receiving portion of the turbine bedplate.

36. The field-replaceable sleeve assembly of claim 34, where the flange is attached to the top side of the turbine bedplate by one or more of dowels, bolts, welding and threads.

37. The field-replaceable sleeve assembly of claim 29, where the sleeve body portion is cylindrical.

38. The field-replaceable sleeve assembly of claim 29, where the turbine bedplate and a nacelle to which the turbine bedplate is coupled are located atop a tower of the wind turbine when the field-replaceable sleeve assembly is installed into the turbine bedplate.

39. The field-replaceable sleeve assembly of claim 29, where the flange portion is circular, curved or rectangular in shape.

40. The field-replaceable sleeve assembly of claim 29, where the flange portion is configured to accommodate a plurality of sleeve body portions.
